(19) United States
(12) Patent Application Publication
(10) Pub. No.: US 2023/0140159 A1
(43) Pub. Date: May 4, 2023

(54) MILK PROTEIN-CONTAINING GRANULAR COMPOSITION, METHOD FOR PRODUCING SAME, AND METHOD FOR IMPROVING DISPERSION PROPERTIES OF MILK PROTEIN-CONTAINING GRANULAR COMPOSITION

(71) Applicant: SUNTORY HOLDINGS LIMITED, Osaka-shi, Osaka (JP)

(72) Inventors: Kyoko Hasebe, Soraku-gun (JP); Noriko Matsui, Soraku-gun (JP)

(73) Assignee: SUNTORY HOLDINGS LIMITED, Osaka-shi, Osaka (JP)

(21) Appl. No.: 17/432,192

(22) PCT Filed: Feb. 18, 2020
(86) PCT No.: PCT/JP2020/006290

§ 371 Date: Aug. 19, 2021

(30) Foreign Application Priority Data
Feb. 20, 2019 (JP) 2019-028603

(51) Int. Cl. A23C 21/08; A23J 3/08; A23L 2/66; A23L 33/19; A23L 2/39

(52) U.S. Cl. CPC A23C 21/08; A23J 3/08; A23L 2/66; A23L 33/19; A23L 2/39

(57) ABSTRACT

The present invention aims to provide a milk protein-containing granular composition which exhibits good dispersibility in a solvent such as water and of which discoloration over time is suppressed, a method of producing the same, and a method of improving the dispersibility of a milk protein-containing granular composition. The present invention relates to a milk protein-containing granular composition containing a milk protein and hydroxypropyl cellulose, and the like.

### TECHNICAL FIELD

The present invention relates to a milk protein-containing granular composition and a method of producing the same. The present invention also relates to a method of improving the dispersibility of a milk protein-containing granular composition, and the like.

### BACKGROUND ART

Milk proteins such as whey protein are high in nutrients. Milk protein-containing powders have therefore been developed as nutritional supplements. Milk protein-containing powders, however, have poor dispersibility in water. When a milk protein-containing powder is added to water, only the surfaces of the powder particles get wet and water does not penetrate into the powder particles, whereby lumps called “mamako (dama)” in Japanese are formed. Once formed, the lumps do not easily break even when they settle in water. It is therefore difficult to disperse the lumps in water. A milk protein-containing powder containing a larger amount of milk protein has poorer dispersibility.

A granulation technique which bonds powder particles to one another into granules has been employed to improve the dispersibility of powder with poor dispersibility. Another technique employed to improve the dispersibility is using a hydrophilic emulsifier. Patent Literature 1 discloses whey protein-containing granules composed of a polyglycerin fatty acid ester having HLB of 13 to 18 and containing lauric acid as a constituent fatty acid. Patent Literature 1 also describes use of a polysaccharide thickener as a binder for granulation.

### CITATION LIST

Patent Literature
Patent Literature 1: JP 5095610 B

### SUMMARY OF INVENTION

Technical Problem

There may be an issue of discoloration over time in the fields of food, beverages, pharmaceutical products, and the like. Such discoloration over time is desired to be suppressed also in milk protein-containing granules. This is because such discoloration may raise a concern about the quality of the food, beverage, or the like even though the discoloration is a change having no influence on the efficacy and flavor. Patent Literature 1 does not mention suppression of discoloration over time of the granules.

The present invention aims to provide a milk protein-containing granular composition which exhibits good dispersibility in a solvent such as water and of which discoloration over time is suppressed, and a method of producing the same. The present invention also aims to provide a method of improving the dispersibility of a milk protein-containing granular composition.

Solution to Problem

The present inventors made intensive studies to respond to the issues above and found that hydroxypropyl cellulose improves the dispersibility of a milk protein-containing granular composition (granules) and suppresses discoloration over time of the composition. Improvement of the dispersibility of milk proteins in water or the like leads to improvement of the solubility thereof.

The present invention encompasses, but is not limited to, the following milk protein-containing granular compositions, methods of producing a milk protein-containing granular composition, and method of improving the dispersibility of a milk protein-containing granular composition, and the like.
(1) A milk protein-containing granular composition containing a milk protein and hydroxypropyl cellulose.
(2) The granular composition according to (1) above, wherein an amount of the milk protein is 30 to 80 wt %.
(3) The granular composition according to (1) or (2) above, wherein the milk protein is whey protein.
(4) The granular composition according to any one of (1) to (3) above, wherein an amount of the hydroxypropyl cellulose is 1 to 5 wt %.
(5) The granular composition according to any one of (1) to (4) above, wherein the granular composition is a granular drink mix.
(6) A method of producing a milk protein-containing granular composition, including granulating milk protein-containing powder using a hydroxypropyl cellulose solution.
(7) The production method according to (6) above, wherein the milk protein is whey protein.
(8) A method of improving dispersibility of a milk protein-containing granular composition, including granulating milk protein-containing powder using a hydroxypropyl cellulose solution in production of a milk protein-containing granular composition.
(9) Use of hydroxypropyl cellulose for improving dispersibility of a milk protein-containing granular composition.

Advantageous Effects of Invention

The present invention can provide a milk protein-containing granular composition which exhibits good dispersibility in a solvent such as water and of which discoloration over time is suppressed, and a method of producing the same. The present invention also can provide a method of improving the dispersibility of a milk protein-containing granular composition.

### DESCRIPTION OF EMBODIMENTS

A milk protein-containing granular composition (hereinafter, also simply referred to as a “granular composition”) of the present invention contains a milk protein and hydroxypropyl cellulose.

Containing hydroxypropyl cellulose, the milk protein-containing granular composition exhibits better dispersibility in a solvent such as water. The granular composition is therefore less prone to form lumps when added to water or the like. Many emulsifiers, when used in a large amount in order to improve the dispersibility of granules, give their bitter taste to the granules. As for hydroxypropyl cellulose, since having almost no flavor itself, it can improve the dispersibility of the granular composition without spoiling the flavor of the composition.

In addition, hydroxypropyl cellulose contained in the granular composition can suppress discoloration over time of the composition.

The milk protein may be whey protein, casein protein, or the like, and is preferably whey protein. One type of milk protein may be used or two or more types of milk proteins may be used. Whey protein refers to a protein contained in milk serum (whey) isolated by removing casein and milk fat from milk such as cow's milk. In one embodiment, the milk protein is preferably cow's milk protein.

The granular composition of the present invention preferably contains the milk protein in an amount of 30 wt % or more, more preferably 35 wt % or more, still more preferably 50 wt % or more, particularly preferably 60 wt % or more. The amount of the milk protein is also preferably 80 wt % or less, more preferably 75 wt % or less. The granular composition of the present invention has good dispersibility even when containing a relatively large amount of the milk protein as mentioned above. In one embodiment, the granular composition preferably contains the milk protein in an amount of 30 to 80 wt %, more preferably 35 to 80 wt %, still more preferably 35 to 75 wt %, even more preferably 50 to 75 wt %, particularly preferably 60 to 75 wt %. The amount of the milk protein can be measured, for example, by the combustion method.

Hydroxypropyl cellulose is a cellulose derivative obtainable by reacting hydroxy groups of cellulose with propylene oxide. Hydroxypropyl cellulose has been widely used as a food additive. The hydroxypropyl cellulose used in the present invention is soluble in water. In terms of dispersibility, the hydroxypropyl cellulose preferably has a low molecular weight, and thus preferably has a weight average molecular weight of 20000 to 150000, more preferably 30000 to 140000, still more preferably 35000 to 100000. The molecular weight of the hydroxypropyl cellulose is easily measurable by gel permeation chromatography (GPC).

The hydroxypropyl cellulose used in the present invention also preferably has a low viscosity. For example, a 8 wt % aqueous solution of the hydroxypropyl cellulose at 20° C. preferably has a viscosity of 50 mPa·s or less, more preferably 1 to 30 mPa·s, still more preferably 1 to 20 mPa·s.

The hydroxypropyl cellulose may be a commercially available one, and is preferably one commercially available as a food additive. Examples of hydroxypropyl cellulose products commercially available as food additives include CELNY SSL (trade name, molecular weight: 40000), CELNY SL (trade name, molecular weight: 100000), and CELNY L (trade name, molecular weight: 140000) which are available from Nippon Soda Co., Ltd. In the present invention, CELNY SSL is preferred.

The amount of the hydroxypropyl cellulose in the granular composition is preferably 1 wt % or more, more preferably 2 wt % or more, in terms of dispersibility of the granular composition and suppression of discoloration thereof. A large amount of the hydroxypropyl cellulose may bring difficulty in production of a granular composition by granulation. The amount of the hydroxypropyl cellulose in the granular composition is, for example, preferably 15 wt % or less, more preferably 5 wt % or less. In one embodiment, the amount of the hydroxypropyl cellulose in the granular composition is preferably 1 to 15 wt %, more preferably 1 to 5 wt %, still more preferably 2 to 5 wt %. The amount of the hydroxypropyl cellulose in the above ranges is preferred because the granular composition has good dispersibility in a solvent such as water and the granular composition is less prone to discoloration over time. The amount of the hydroxypropyl cellulose in the above ranges is preferred also because, for example, the productivity is less prone to decrease when the granular composition is produced by the later-described granulation method.

In terms of dispersibility of the granular composition and the like, the ratio by weight of the hydroxypropyl cellulose to the milk protein (hydroxypropyl cellulose/milk protein) in the granular composition is preferably 0.01 or more, more preferably 0.02 or more, while preferably 0.07 or less, more preferably 0.06 or less. In one embodiment, the ratio by weight of the hydroxypropyl cellulose to the milk protein (hydroxypropyl cellulose/milk protein) in the granular composition is preferably 0.01 to 0.07, more preferably 0.02 to 0.06.

The milk protein-containing granular composition of the present invention may contain a component(s) other than the milk protein and the hydroxypropyl cellulose according to the application and the like. For example, the composition may contain a component(s) usable in food, beverages, or the like in the form of granules. The granular composition may contain an additive(s) usable in food, beverages, or pharmaceutical products. Examples of the additive(s) include excipients (e.g., dextrin, starch), thickeners, emulsifiers, sweeteners, and flavorings. The milk protein-containing granular composition may contain minerals, vitamins, polyphenols, free amino acids, and the like.

The granular composition of the present invention is usable as an oral composition, and is suitable for food, beverages, and the like. In one embodiment, the granular composition of the present invention may be consumed directly as food or a beverage. Also, the granular composition of the present invention may be mixed into food or a beverage.

In one embodiment of the present invention, the granular composition is suitable as a granular drink mix. The granular drink mix is granules for drinking which are mixed into a solvent for drinking such as water, cow's milk, or the like to prepare a beverage. The granular composition of the present invention has good dispersibility in a solvent such as water and is drinkable when it is dispersed in a solvent for drinking.

The granular composition of the present invention preferably has a volume average particle size of 200 μm or more, more preferably 230 μm or more, still more preferably 250 μm or more, while preferably 400 μm or less, more preferably 300 μm or less. In one embodiment, the granular composition preferably has a volume average particle size of 200 to 400 μm, more preferably 230 to 300 μm, still more preferably 250 to 300 μm. The volume average particle size can be determined by laser diffraction/scattering, more specifically by the method described in the examples.

The granular composition of the present invention can be produced by any method such as granulating milk protein-containing powder using a hydroxypropyl cellulose solution. This method can provide granules in which particles of the milk protein-containing powder are bonded to one another via the hydroxypropyl cellulose. Such granules in which particles of the milk protein-containing powder are bonded to one another via the hydroxypropyl cellulose are one preferred embodiment of the granular composition of the present invention.

A method of producing a milk protein-containing granular composition including granulating milk protein-containing powder using a hydroxypropyl cellulose solution is also one embodiment of the present invention. Hydroxypropyl cellulose is suitable as a binder. Granulation using the hydroxypropyl cellulose as a binder can produce a milk protein-containing granular composition having good dispersibility in a solvent such as water. Also, as shown in the examples, discoloration over time was suppressed in the milk protein-containing granular composition produced by granulation using a hydroxypropyl cellulose solution, as compared to that in granular compositions obtained by granulation using, for example, dextrin, a polysaccharide thickener, or the like.

The milk protein-containing granular composition produced by the production method of the present invention is one preferred embodiment of the milk protein-containing granular composition of the present invention. A granular composition obtained by granulation is also referred to as a granulated product.

Granulation can be performed by spraying a hydroxypropyl cellulose solution to milk protein-containing powder. The method of granulating milk protein-containing powder using a hydroxypropyl cellulose solution may be any method such as fluidized bed granulation, tumbling granulation, or the like. In the present invention, granulation is preferably fluidized bed granulation. Fluidized bed granulation can be performed by fluidizing a powder raw material in a commonly used fluidized bed granulation device, and spraying a spray liquid to the resulting fluidized material. The granules obtained by granulation are then preferably dried.

In one embodiment, the production method of the present invention preferably includes spraying a hydroxypropyl cellulose solution for fluidized bed granulation to milk protein-containing powder. Fluidized bed granulation by spraying a hydroxypropyl cellulose solution is preferred because the milk protein-containing granules evenly coated with the hydroxypropyl cellulose can be obtained. In addition, fluidized bed granulation facilitates production of granules having a uniform particle size with a smaller variation in particle size distribution as compared to granulation by, for example, a tumbling fluidized bed method. Granules obtainable by fluidized bed granulation is more likely to be dispersed in water or the like as they are porous (have pores). Thus, fluidized bed granulation enables production of a granular composition having better dispersibility.

The milk protein-containing powder (powder composition) used in granulation may contain a component(s) other than the milk protein, such as the above-described components and additives (e.g., excipients) usable in food, beverages, or the like in the granular form. The milk protein-containing powder can be produced by mixing a milk protein or a powder raw material containing the milk protein with additive(s), other component(s), and/or the like as desired. The production method of the present invention may include preparing milk protein-containing powder.

In the production method of the present invention, a preferred embodiment of the milk protein is the same as that of the milk protein-containing granular composition of the present invention described above, and whey protein is preferred.

Examples of whey protein-containing powder raw materials include whey protein concentrates (WPC) (protein content is about 80 wt %) and whey protein isolates (WPI) (protein content is 90 wt % or more). The milk protein-containing powder raw material can be a commercially available one. Examples of commercially available whey protein-containing powder raw materials include Lactocrystal plus (trade name, Nippon Shinyaku Co., Ltd.).

The milk protein-containing powder used in granulation preferably contains the milk protein in an amount of 30 wt % or more, more preferably 35 wt % or more, still more preferably 50 wt % or more, particularly preferably 60 wt % or more. The amount of the milk protein in the powder is preferably 85 wt % or less, more preferably 80 wt % or less. In one embodiment, the milk protein-containing powder preferably contains the milk protein in an amount of 30 to 85 wt %, more preferably 35 to 80 wt %, still more preferably 50 to 80 wt %, particularly preferably 60 to 80 wt %. Granulation of such powder containing a relatively large amount of the milk protein using a hydroxypropyl cellulose solution enables production of a milk protein-containing granular composition containing a relatively large amount of the milk protein and having good dispersibility. In addition, use of hydroxypropyl cellulose enables production of a milk protein-containing granular composition of which discoloration over time is suppressed.

The hydroxypropyl cellulose and a preferred embodiment thereof are the same as those described above for the granular composition of the present invention. The hydroxypropyl cellulose solution is a solution in which the hydroxypropyl cellulose is dissolved in a solvent. The production method of the present invention may include preparing a hydroxypropyl cellulose solution. The hydroxypropyl cellulose solution can be prepared by dissolving the hydroxypropyl cellulose in a solvent. The solvent can be water, ethanol, or the like, and is preferably water. The hydroxypropyl cellulose solution is preferably an aqueous solution of the hydroxypropyl cellulose. Granulation using an aqueous solution of the hydroxypropyl cellulose enables production of a milk protein-containing granular composition of which discoloration over time is suppressed.

The hydroxypropyl cellulose solution preferably has a hydroxypropyl cellulose concentration of 2 wt % or more, more preferably 5 wt % or more, while preferably 15 wt % or less, more preferably 10 wt % or less, in order to achieve a viscosity for easy spraying of the solution. In one embodiment, the hydroxypropyl cellulose solution preferably has a hydroxypropyl cellulose concentration of 2 to 15 wt %, more preferably 5 to 10 wt %.

The hydroxypropyl cellulose is preferably used in such an amount that makes the resulting milk protein-containing granular composition contain the hydroxypropyl cellulose in an amount of preferably 1 to 15 wt %, more preferably 1 to 5 wt %, still more preferably 2 to 5 wt %.

In the production method of the present invention, the hydroxypropyl cellulose is used in an amount that gives a ratio by weight of the hydroxypropyl cellulose to the milk protein (hydroxypropyl cellulose/milk protein) of preferably 0.01 or more, more preferably 0.02 or more, while preferably 0.07 or less, more preferably 0.06 or less. In one embodiment, the hydroxypropyl cellulose is used in an amount that gives a ratio by weight of the hydroxypropyl cellulose to the milk protein (hydroxypropyl cellulose/milk protein) of preferably 0.01 to 0.07, more preferably 0.02 to 0.06.

The granulation conditions may be any conditions under which the milk protein-containing powder particles are bonded to one another via the hydroxypropyl cellulose for granulation and then dried. The conditions may be adjusted as appropriate.

The hydroxypropyl cellulose is useful in improving the dispersibility of a milk protein.

The present invention encompasses a method of improving the dispersibility of a milk protein-containing granular composition, including granulating milk protein-containing powder using a hydroxypropyl cellulose solution in production of a milk protein-containing granular composition. The present invention also encompasses use of the hydroxypropyl cellulose for improving the dispersibility of a milk protein-containing granular composition. The milk protein, hydroxypropyl cellulose, and preferred embodiments thereof are the same as those described for the milk protein-containing granular composition of the present invention and the production method of the present invention.

In production of a milk protein-containing granular composition, the method including granulating milk protein-containing powder using a hydroxypropyl cellulose solution can also be used as a method of suppressing discoloration of a milk protein-containing granular composition. The present invention also encompasses use of hydroxypropyl cellulose for suppressing discoloration of a milk protein-containing granular composition.

### EXAMPLES

Hereinafter, examples that more specifically describe the details of the present invention are shown. The scope of the present invention is not limited to these examples.

The raw materials used in the examples and comparative examples are listed below.

Whey protein powder: Lactocrystal plus (trade name) (protein content: 91 wt %) available from Nippon Shinyaku Co., Ltd.

Hydroxypropyl cellulose (HPC): CELNY SSL (trade name) available from Nippon Soda Co., Ltd., molecular weight (in weight): 40000

Guar gum: Neosoft G (trade name) available from Taiyo Kagaku Corporation

Dextrin: Sandec #70 (trade name) available from Sanwa Starch Co., Ltd.

Polysaccharide thickener: San support S-4 (trade name) available from San-Ei Gen F.F.I., Inc.

The volume average particle sizes of the granules and the raw materials were measured by the following method.

The granular composition (or whey protein powder) in an amount of 3 g was placed on a sample tray and the volume average particle size of the composition was analyzed by laser diffraction/scattering with Microtrac MT3300EX II (MicrotracBEL Corp.).

The whey protein powder (trade name: Lactocrystal plus) had a volume average particle size of 153.8 μm.

### Example 1

A whey protein-containing granular composition (hereinafter, also referred to as “protein-containing granules”) was prepared using raw materials in proportions shown in Table 1.

Specifically, a powder mix (294 g) containing 240 g of whey protein powder and 54 g of dextrin was granulated in a fluidized bed granulator (FD-LAB-1, available from Powrex Corporation) using a 8 wt % aqueous solution of HPC as a spray liquid. Here, the powder mix was charged into the granulator and mixed for three minutes, followed by granulation for 10 to 20 minutes, with the spray liquid (75 g) being sprayed at a rate of 6.5 to 7.0 mL/min (product temperature: 35° C. to 40° C., charge air temperature: 60° C. to 70° C.). The granulated product was dried in the granulator for four minutes, and then taken out of the granulator. Thereby, protein-containing granules were obtained.

When the HPC concentration was 8 wt %, the viscosity (20° C.) of the aqueous solution of HPC was 15 mPa·s. The viscosity (20° C.) of the aqueous solution of HPC was measured by the following method.

A 200-mL beaker was charged with 100 mL of an aqueous solution of HPC. The viscosity of the solution was measured on a viscometer (Toki Sangyo Co., Ltd) with a rotational speed of 30 rpm.

### Example 2

A whey protein-containing granular composition was produced by the same procedure as in Example 1, except that the powder mix used was changed to a powder mix (294 g) of 120 g of whey protein powder and 174 g of dextrin.

### Comparative Example 1

A whey protein-containing granular composition was prepared by the same procedure as in Example 1, except that the proportions of the raw materials were changed to the proportions shown in Table 1. Specifically, protein-containing granules were obtained by the same procedure as in Example 1, except that the powder mix used was changed to a powder mix of 240 g of whey protein powder and 60 g of dextrin and the spray liquid was changed to water.

### Comparative Examples 2 to 4

A whey protein-containing granular composition was prepared by the same procedure as in Example 1, except that the proportions of the raw materials were changed to the proportions shown in Table 1. Specifically, in Comparative Example 2, the spray liquid was changed to a 0.3 wt % aqueous solution of guar gum. In Comparative Example 3, the spray liquid was changed to a 27 wt % aqueous solution of dextrin. In Comparative Example 4, the spray liquid was changed to a 0.1 wt % aqueous solution of a polysaccharide thickener. Except for these changes, protein-containing granules of Comparative Examples 2 to 4 were obtained by the same procedure as in Example 1.

The blending ratios in the protein-containing granules produced in Examples 1 and 2 and Comparative Examples 1 to 4 are shown in Table 1. The protein-containing granules produced in each of Examples 1 and 2 had a volume average particle size of 251.7 μm. The protein-containing granules produced in Comparative Example 3 had a volume average particle size of 185.9 μm.

The “Protein content in granules” shown in Table 1 is the amount (wt %) of whey protein in the obtained protein-containing granules. The “HPC/protein” shown in the table is the ratio by weight of the hydroxypropyl cellulose to whey protein (hydroxypropyl cellulose/whey protein) in the protein-containing granules.

The dispersibility and stability of the protein-containing granules were evaluated by the following respective methods.

### [Dispersibility Evaluation]

The protein-containing granules in an amount of 5.8 g were added to 80 mL of room temperature water in a 200-mL beaker, and manually stirred with a dispensing spoon at a stirring speed of about 200 rpm. The amount of undissolved granules found at the liquid level and the bottom of the beaker was determined every 10 seconds during stirring. The dispersibility of the granules was evaluated based on the following criteria (on a scale of 1 to 5).

### (Evaluation Criteria for Dispersibility)

5: Almost no undissolved granules were found at the liquid level and the bottom of the beaker after stirring for 10 seconds.
4: Almost no undissolved granules were found at the liquid level and the bottom of the beaker after stirring for 30 seconds.
3: Almost no undissolved granules were found at the liquid level and the bottom of the beaker after stirring for 60 seconds.
2: Some undissolved granules were found at the liquid level and the bottom of the beaker after stirring for 60 seconds.
1: Many undissolved granules were found at the liquid level and the bottom of the beaker after stirring for 60 seconds.

### [Stability Evaluation]

The protein-containing granules obtained in each of Examples 1 and 2 and Comparative Examples 1 to 4 in an amount of 2 g were placed on a plastic petri dish and stored at 40° C. and 75% RH for four days (storage test). The Lab values (i.e., L, a, and b values) of each sample before and after the storage were measured with a spectrophotometer (Nippon Denshoku Industries Co., Ltd., SE7700).

The Lab color difference (ΔE) was determined from the following formula. In the formula, L1, L2, a1, a2, b1, and b2 are as follows.

L1: L value before storage test

L2: L value after storage test

a1: a value before storage test

a2: a value after storage test

b1: b value before storage test

b2: b value after storage test

ΔE=((L2−L1)²+(a2−a1)²+(b2−b1)²)^{1/2}

The evaluation results of dispersibility and stability are shown in Table 1. The evaluation results of stability are indicated as color differences (ΔE values). When two colors with a color difference of 1.2 are set side by side for evaluation, most people easily recognize the color difference. Thus, when the color difference before and after the storage test was less than 1.2, the change in color during storage was evaluated to be small.

Based on the dispersibility evaluation and the stability evaluation, the comprehensive evaluation was made based on the following criteria.

Good: the granules scored 4 points or higher in the dispersibility evaluation and showed a ΔE value of 0 or more and less than 1.2 in the stability evaluation.

Poor: the granules scored less than 4 points in the dispersibility evaluation and/or showed a ΔE value of 1.2 or more in the stability evaluation

TABLE 1

| | | | | Comparative | Comparative | Comparative | Comparative |
|---|---|---|---|---|---|---|---|
| | | Example 1 | Example 2 | Example 1 | Example 2 | Example 3 | Example 4 |
| Powder | Whey protein powder | 80 | 40 | 80 | 80 | 80 | 80 |
| (wt %) | Dextrin | 18 | 58 | 18 | 18 | 18 | 18 |
| Spray | HPC | 2 | 2 | — | — | — | — |
| liquid | Guar gum | — | — | — | 2 | — | — |
| (wt %) | Dextrin | — | — | — | — | 2 | — |
| | Polysaccharide thickener | — | — | — | — | — | 2 |

| | | | | | | |
|---|---|---|---|---|---|---|
| Protein content in granules (wt %) | 73 | 36 | 73 | 73 | 73 | 73 |
| HPC/protein | 0.03 | 0.05 | — | — | — | — |
| Dispersibility | 4 | 4 | 1 | 3 | 4 | 3 |
| Color difference | 1.07 | 0.86 | 1.28 | 2.19 | 3.14 | 2.36 |
| Comprehensive evaluation | Good | Good | Poor | Poor | Poor | Poor |

In the dispersibility evaluation for Comparative Example 1, many undissolved granules were found at the liquid level and the bottom of the beaker after stirring for 60 seconds. In Comparative Example 2 in which guar gum was used, undissolved granules were found at the liquid level and the bottom of the beaker after stirring for 30 seconds, but almost no undissolved granules were found at the liquid level and the bottom of the beaker after stirring for 60 seconds. The same tendency was seen in Comparative Example 4 in which a polysaccharide thickener was used. In Examples 1 and 2 in which HPC was used and Comparative Example 3 in which dextrin was used, no undissolved granules were found at the liquid level and the bottom of the beaker after stirring for 30 seconds, meaning that good dispersibility was achieved.

Meanwhile, in the stability evaluation for Comparative Example 3, a color difference was observed when the samples before and after the accelerated test (the storage test above) were placed side by side and the colors thereof were compared visually and when the color difference values of the samples measured with the spectrophotometer were compared. The same tendency was seen in Comparative Example 2 and Comparative Example 4. In contrast, in Examples 1 and 2 in which granulation was performed using a HPC solution, the samples hardly underwent a change in color after the storage test.

These results therefore show that containing HPC, the milk protein-containing granular compositions exhibit better dispersibility, and also discoloration over time thereof is suppressed, whereby better stability is achieved.

### Example 3

Aqueous solutions of HPC with various HPC concentrations (HPC: 6 wt %, 10 wt %, or 16 wt %) were prepared. The viscosity of each solution was measured by the same procedure as in Example 1. The 6 wt % aqueous solution of HPC had a viscosity (20° C.) of 8 mPa·s, the 10 wt % aqueous solution of HPC had a viscosity (20° C.) of 25 mPa·s, and the 16 wt % aqueous solution of HPC had a viscosity (20° C.) of 101.5 mPa·s.

Granulation was performed by the same procedure as in Example 1, except that the aqueous solutions of HPC prepared above were used as the spray liquids, so that whey protein-containing granular compositions were produced.

When the aqueous solution with a HPC concentration of 5 wt % and the aqueous solution with a HPC concentration of 10 wt % were used as spray liquids, whey protein-containing granular compositions were successfully produced by the same procedure as in Example 1. The 16 wt % aqueous solution of HPC was difficult to spray.

1. A milk protein-containing granular composition comprising a milk protein and hydroxypropyl cellulose.

2. The granular composition according to claim 1,
wherein an amount of the milk protein is 30 to 80 wt %.

3. The granular composition according to claim 1,
wherein the milk protein is whey protein.

4. The granular composition according to claim 1,
wherein an amount of the hydroxypropyl cellulose is 1 to 5 wt %.

5. The granular composition according to claim 1,
wherein the granular composition is a granular drink mix.

6. A method of producing a milk protein-containing granular composition, comprising granulating milk protein-containing powder using a hydroxypropyl cellulose solution.

7. The production method according to claim 6,
wherein the milk protein is whey protein.

8. A method of improving dispersibility of a milk protein-containing granular composition, comprising
granulating milk protein-containing powder using a hydroxypropyl cellulose solution in production of a milk protein-containing granular composition.

9. Use of hydroxypropyl cellulose for improving dispersibility of a milk protein-containing granular composition.
